(19) United States
(12) Patent Application Publication
(10) Pub. No.: US 2011/0119868 A1
(43) Pub. Date: May 26, 2011

(54) Method of Making A Custom Sports Handle

(76) Inventor: Robert LaLonde, Wyomissing, PA (US)

(21) Appl. No.: 12/947,373

(22) Filed: Nov. 16, 2010

Related U.S. Application Data
(60) Provisional application No. 61/263,566, filed on Nov. 23, 2009.

(51) Int. Cl. B25G 1/10; B29C 39/02; B05D 3/12

(52) U.S. Cl. 16/421; 264/129; 427/299; 425/470

(57) ABSTRACT

A custom sports handle having a grip portion, at least one elongated projection, and a tactile layer. The grip portion includes a distal end and a proximal end. The at least one elongated projection is integrally positioned along a surface of the grip portion, while the tactile layer prepared over the surface of the grip portion by way of a coating process.

### CROSS-REFERENCE TO RELATED APPLICATIONS

This application is claims benefit of the filing date under 35 U.S.C. §119(e) of Provisional Patent Application No. 61/263,566, filed Nov. 23, 2009.

### FIELD OF INVENTION

The present invention relates to a method of making a sports handle, and more particularly, to a method of making a customized sport handle.

### BACKGROUND

As is common in many sports, the handle, used to grip sports equipment, is generally rigid and smooth. This stock handle is difficult to grasp and may become slippery, especially during the course of play. Additionally, moisture from the hand and environment may coat the surface of the handle, making the grip less secure. Hard stock handles are generally perceived as uncomfortable and does not provide an adequate grip during use. As a result, in a sport such as ice hockey, players will commonly tape the handle of a hockey stick to modify and customize the stock handle. This “work up” of the stock handle provides the player with a more secure grip, as well as added cushion and tactile properties.

Since hockey sticks are generally breakable, a hockey player may go through several sticks over a short time period. Ice hockey sticks have traditionally been made from wood, but in recent years, sticks have been commonly prepared using materials such as aluminum, aramid (kevlar), fiberglass, carbon fiber, and other composite materials. These sticks can be manufactured with more desired material and mechanical properties than their wooden counterparts. Newer hockey sticks are made from several components, including a handle, shaft, and blade. The shafts are generally hollow, and made of composite materials. The blade portion and handle portion, which are the replaceable component to the stick, connect to the hollow shaft at opposing ends.

FIG. 1 illustrates a stock handle 10 of a known hockey stick (not shown). The handle 10 may be replaceable and connects to one end of a hockey stick shaft (not shown), while a blade (not shown) connects at another end. The handle 10, which is positioned at one end of the shaft 2, includes a grip portion 12. The grip portion 12 is griped by one hand during use, while the other hand is positioned further down, away from the handle 10, along the shaft 2.

As discussed, a user normally prepares a “work-up” 50 as a modification to the stock handle 10. For instance, the user may modify the handle 10 by spinning a roll of adhesive tape 20 into a long, twisted strip 26, and then helically wrapping the strip 26 around the grip portion 12 of the stock handle 10. This type of modification creates friction along an otherwise hard, smooth stock handle 10, and thus preparing a “work-up” 50.

A modified “work-up” 50 may also includes a flange 22 formed on the distal end 16 of the handle 10, or a ridge 44 formed at the other end of the grip portion 12. A user can use adhesive tape 20 to form a flange 22, or perform modifications by removing material with a tool. The user will generally use adhesive tape 20 to cover the entirety of the grip portion 12, as shown, in order to provide texture, tact, and cushion to the handle 10, as well as a unique configuration.

In the case where the handle 10 is replaceable and inserted into the hollow shaft (not shown), an attachment portion (not shown) is provided on the proximal end of the grip portion 12, which is dimensioned and configured in such a way that the handle 10 is received by a hollow shaft (not shown). The handle 10 would attach to hollow shaft (not sown) using an attachment mechanism, such as an adhesive 29, screw, or other attachment means know to secure the handle 10 with the shaft (see FIG. 1A).

Other modifications are possible, including the use of ornamental elements 30 (positioned on the grip portion 12, and wrapped under adhesive tape 20) and ornamental shapes of the handle, such as an arcuate hilt (not shown). In fact, the “work-up” 50, shown in FIG. 1, is an illustration of just one possible configuration, which is unlimited and very much custom to the user. Although the handle 10 is customized by both ornamental appearance and tactile feel, replicating this customization from stick to stick, or handle 10 to handle 10, is burdensome. It is therefore desirable to provide a replacement for these unique “work-up” handles, as well as a method to prepare a “work-up” of the replaceable handle in an efficient and economical way.

### SUMMARY

The invention provides a custom sports handle manufactured to specifications sent in a kit having a work up of a stock handle. The custom sports handle includes a grip portion having a distal end and a proximal end and at least one elongated projection integrally positioned along a surface of the grip portion, while a tactile layer is prepared over the surface of the grip portion by way of a coating process.

### BRIEF DESCRIPTION OF THE DRAWINGS

The invention will now be described with reference to the accompanying figures of which:

FIG. 1 is a perspective view of a “work-up” of a known stock handle;

FIG. 2 is a perspective view of a custom sports handle according to the invention;

FIG. 2A is an exploded section of a tactile layer of the custom sports handle, according to the invention;

FIG. 3A is a perspective view of a molding kit according to the invention;

FIG. 3B is a perspective view of another embodiment of the molding kit of FIG. 3a;

FIG. 4 is a flow diagram detailing how a custom handle is prepared utilizing the molding kit according to the invention;

FIG. 5 is a flow diagram detailing how a custom handle is prepared utilizing a work-up of a virtual handle, according to the invention;

FIG. 6A is a side view of an attachment portion of the custom sports handle of FIG. 2 and a hollow shaft of a known hockey stick; and

FIG. 6B is an exploded perspective view of an attachment receiving piece for the attachment portion of FIG. 6a, according to the invention.

### DETAILED DESCRIPTION OF THE EMBODIMENT(S)

The invention will now be described in greater detail with the aid of the embodiments.

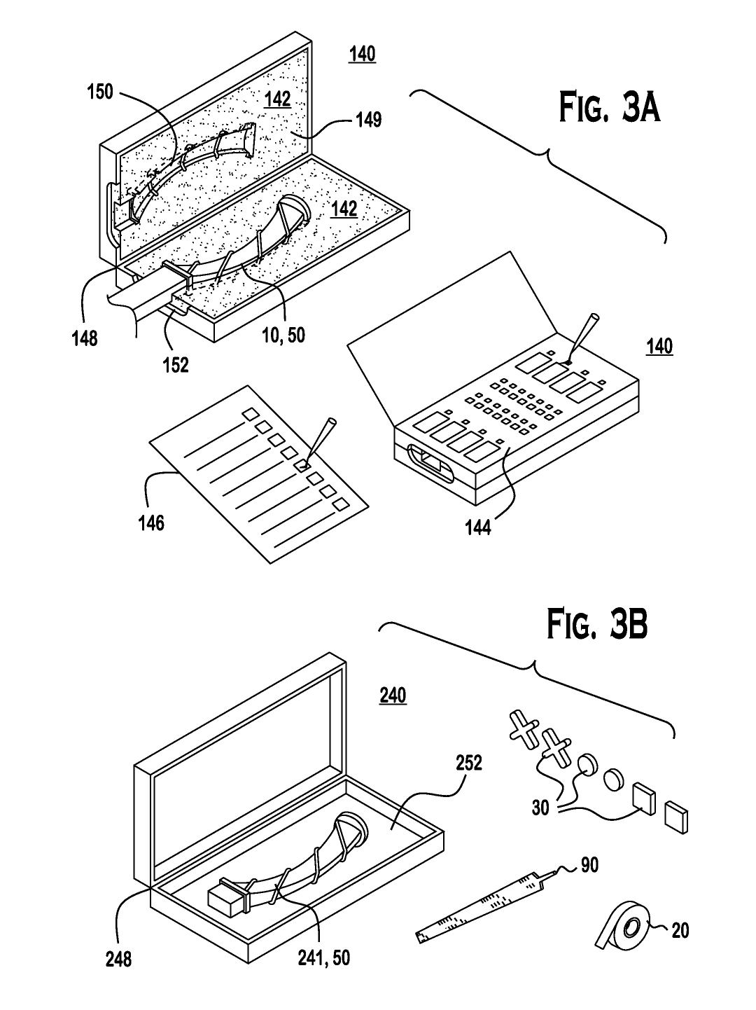

FIG. 2 illustrates a custom sports handle 60 being a replaceable component for a known hockey stick, and including a grip portion 62 and an attachment portion 68.

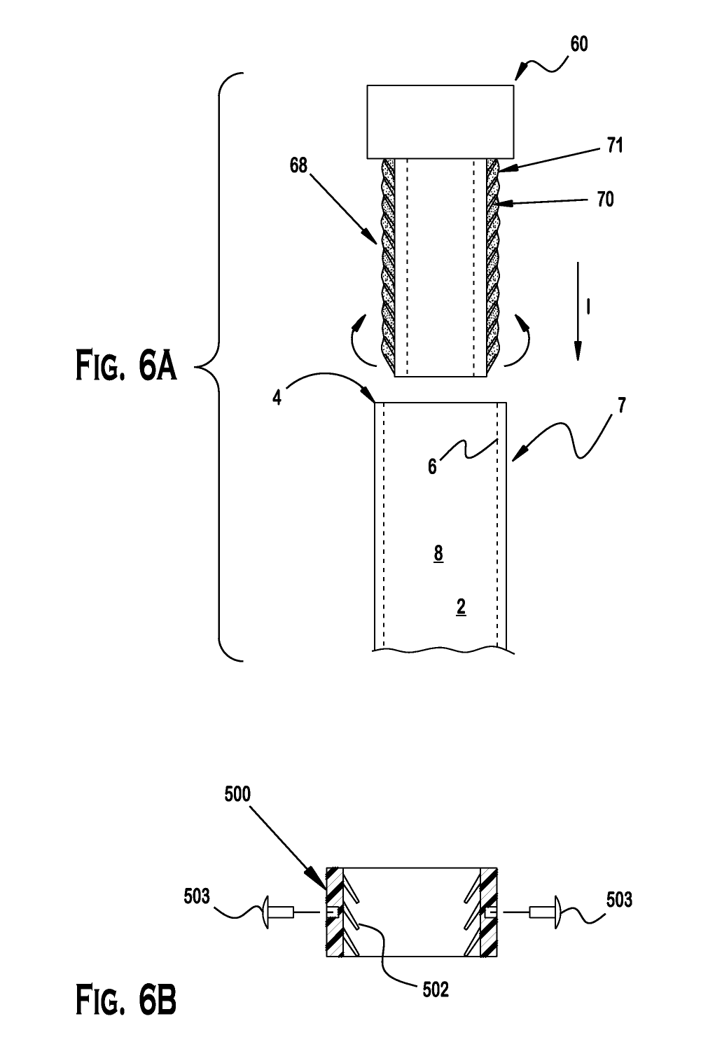

The grip portion 62 includes a distal end 66 and a proximal end 64. The proximal end 64 connects to a hollow shaft 2 (see also FIG. 6a) of a hockey stick, while the distal end 66 being one end of the known hockey stick.

The custom sports handle 60, according to the invention, includes a monolithic grip portion 62. The custom sports handle 60 can be designed as an integral component of a monolithic hockey stick, or prepared as a replaceable butt end for a hollow shaft, as shown.

The monolithic grip portion 62, in FIG. 2, includes a flange 72, at least one elongated projection 74, and at least on ridge 76; each component is prepared as an integral construction of the monolithic grip portion 62. In fact, each monolithic component may vary in size, shape, and configuration. However, their size, shape, and configuration will mock the contours and shape of the “work-up” 50 that is used as a basis for the construction of the custom sports handle 60.

The attachment portion 68 connects to the hollow shaft 2, and is dimensioned such that a surface of the attachment portion 68 fits snug within the hollow shaft 2. The attachment portion 68 is configured to include an attachment mechanism 69 to hold a position within the hollow shaft 2. The attachment mechanism 69 may be an adhesive 70, screw (not shown), or other attachment means known to the art. In the embodiment shown, the attachment mechanism 69 includes retention members 70, which are described in further detail below.

The custom sports handle 60, and more specifically, the grip portion 62 has a surface 61 made from the same material as a body of the grip portion 62. Additionally, a tactile layer 80 is prepared over the surface 61 of the grip portion 62 by way of a coating process. In the embodiment shown, the coating process involves spraying a layer of a soft tactile material over the surface 61 to form the tactile layer 80. In the embodiment shown, the entire surface 61 of the grip portion 62 has a coating of the tactile layer 80. However, the tactile layer 80 may be alternatively applied only to a selected portion of the surface 61.

The tactile layer 80 is a composition, having a blend of materials according to the user specification. The user selects specific tactile properties (i.e. roughness, cushion, and moisture retention), which is then used to prepare the slurry of materials making up the tactile layer 80. For example, in the embodiment shown, the tactile layer 80 is a mixture of rubberized material 82 (for cushion and tact), grit 83 (for roughness), silica 84 (for moisture control), and cork 86. The mixture is further combined with a thermoset or binder 85 (see FIG. 2A). If used, the thermoset or binder 85 provides that the tactile layer 80 remains enduring and robust. In other embodiments, other combinations of materials are available, including various polymers and/or organics, such as cork 86. Generally, the tactile layer 80 is applied using a coating process, which will be discussed, as a manufacturing technique, below.

In the embodiment shown, the custom sports handle 60 may be a replacement handle, or is incorporated into the design and fabrication of a new hockey stick. Accordingly, the user can order new hockey sticks having the custom sports handle 60 constructed as a monolithic component of the shaft 2; the whole stick prepared from either wood or composite.

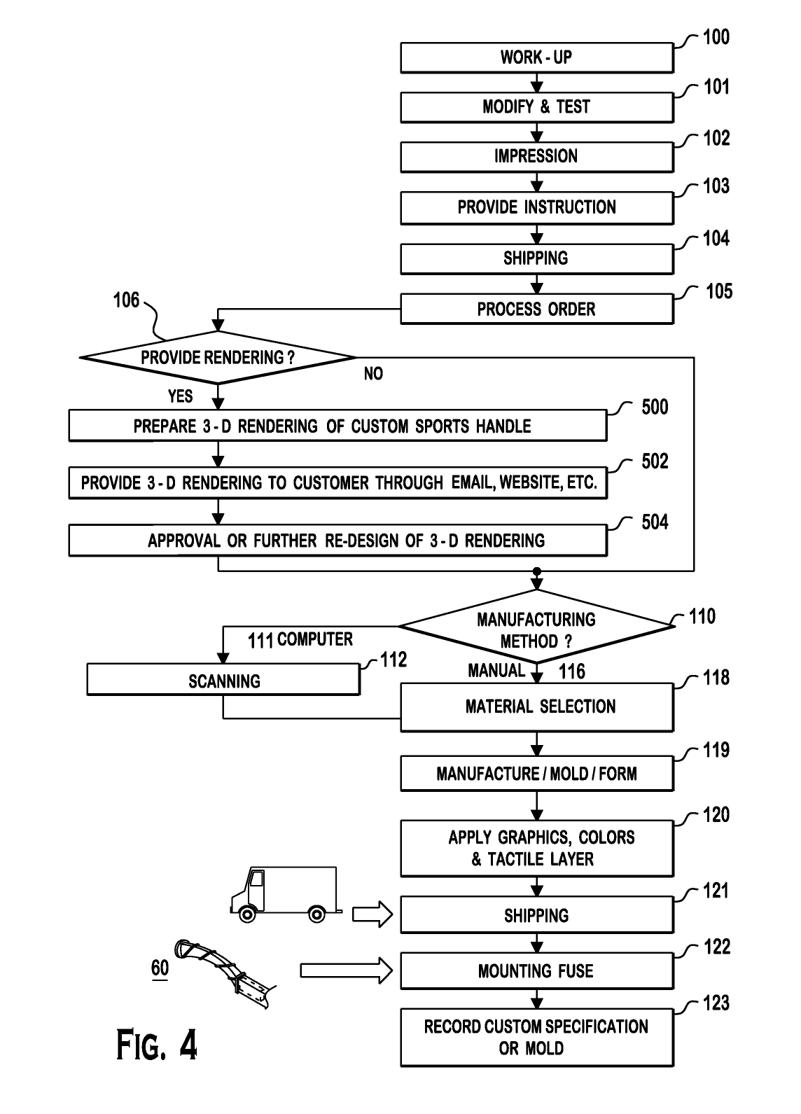

FIG. 3A shows a molding kit 140 used by the consumer to prepare an impression of the “work-up” 50 of a known stick handle 10. In the embodiment shown, the molding kit 140 opens to a hollow interior and is filled with a deformable molding material 142. When force is applied to the deformable molding material 142, an impression 150 of the “work-up” 50 is made.

Accessories and tools, such as adhesive tape 20 and/or a file 90, are provided with the molding kit 140. The accessories and tools may be separately packaged with the molding kit 140. However, in the embodiment shown, the accessories and tools are packed with the molding kit 140, whereby a transparent sheet (i.e. polymer, regenerated cellulose, etc.) wraps the entirety of the molding kit 140 with the accessories and tools included.

When unpackaged, the molding kit 140 opens along a middle section, or spine 148, exposing impression sections 149. For instance, as shown, the molding kit 140 opens like a book. Impression sections 149, of equal size, are positioned on both sides of the spine 14, so that a full impression 150 is captured when a “work-up” 50 of a modified stock handle 10 is cast.

Additionally, apertures 152 are included into the molding kit 140 design. Each aperture 152 is located along one side surfaces of the molding kit 140 and match up to each other when the molding kit 140 is closed. Therefore, a larger hole is prepared to make room for the “work-up” 50 to be completely closed in the molding kit 140, as the impression is being performed.

The deformable molding material 142 may be selected from a variety of materials, including plastic, clay, or any other material capable of plastic deformation. So, when the “work-up” 50 is positioned in the molding kit 140, and then subsequently closed, an impression 150 is prepared in both impression sections 149 of the molding kit 140. The impression 150 not only provides information on shape, but also dimensional specifications of the “work-up” 50. As a result, the impression 150 can be used as a basis in the manufacturing of the custom sports handle 60, which is discussed in further detail below.

The molding kit 140, according to the invention, includes either an instruction sheet 146 or options chart 144, with either acting as a checklist of user selected options. In the embodiment shown, the available options include material composition (i.e. wood, polymer, or composite), color, tactile properties such as hardness and adhesion, and quantity. However, a variety of other options may be available in other embodiments. In fact, the instruction sheet 146 or options chart 144 would further include an area for written instructions, where the consumer can write in more specialized instructions.

The molding kit 140 includes a sealing mechanism 143, in the embodiment shown, which self seals the molding kit 140 when closed. The sealing mechanism 143 may be Velcro or an adhesive applied along a surface of the molding kit 140. This sealing mechanism 143 is used to seal the impression sections 149 of the molding kit 140 before shipment. In the embodiment shown, the sealing mechanism 143 of the molding kit 140 self seals the impression 150 inside the molding kit 140, and self postage (not shown) may be provided for quick and easy shipment to the manufacturer.

In the alternative embodiment, as shown in FIG. 3B, the deformable molding material 142 is removed from the molding kit 140. The alternate molding kit 240, in FIG. 3B, includes a mock handle 241 placed in a cavity 252, instead. The cavity 252 may be otherwise empty or include packing material. The mock handle 241 is a stock handle and is packaged along with similar accessories and tools, as shown in FIG. 3A. The mock handle 241 is then used to prepare a “work-up” 50, which is placed into the cavity 252.

As discussed above, the molding kit 140 may include accessories and tools. These accessories and tools, such as adhesive tape 20, ornamental elements 30, or tools (such as a file 90 or sandpaper 91), may be used to prepare the “work-up”. In the alternate embodiment, the mock handle 241 may otherwise be modified, already. This mock handle 241 comes pre-shaped, either straight or having a unique design, such as an arcuate hilt in the grip portion (not shown). Therefore, different molding kits 240 are available, having various combination of shaped mock handles 241, accessories, and/or tool combinations in the molding kit 240.

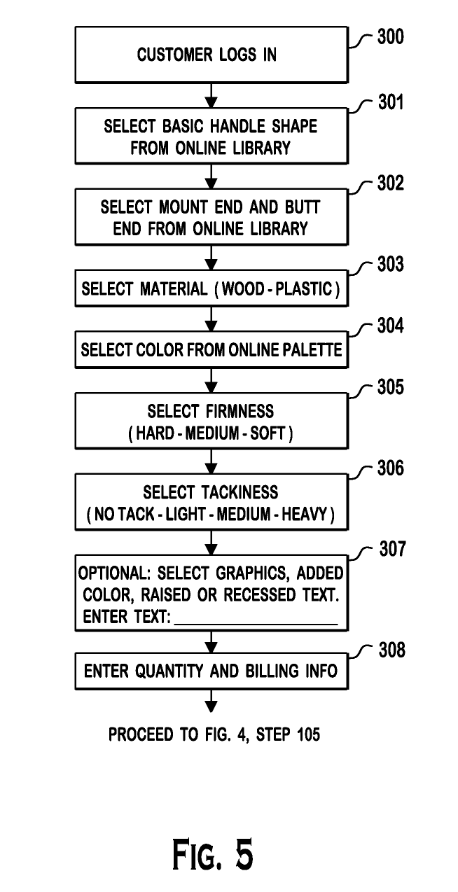

FIG. 4 illustrates a flow diagram of a method and means for preparing a custom sports handle 60, according to the invention. At the heart of this particular method is molding kit 140.

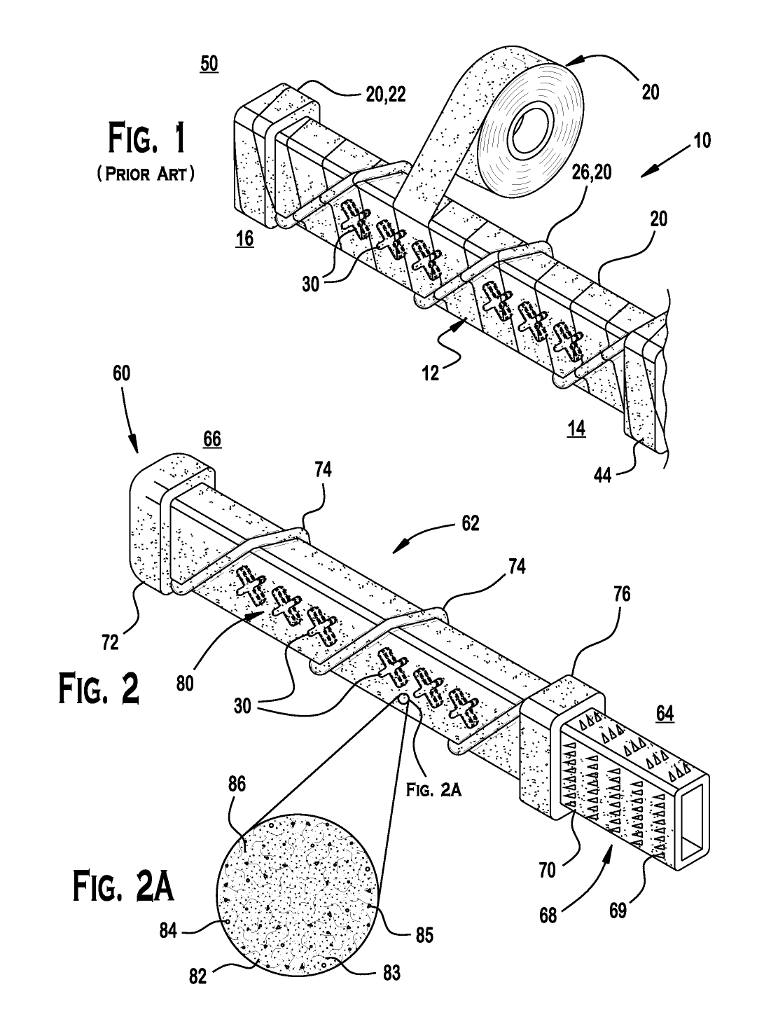

At step 100, a customer prepares a custom shape or “work-up” 50 of the stock handle 10. For instance, the customer would shape and modify a stock handle 10, such as the stock handle of FIG. 1, using a variety of accessories and tools, including adhesive tape 20, ornamental elements 30, file 90, and sandpaper 91. As discussed above, the accessories and tools may be packaged in the molding kit 140.

Further modification and/or customization of the original stock handle 10 is performed, until the customer believes the “work-up” 50 of the handle 10 is satisfactory for use, by testing the performance (step 101).

The customer then makes an impression 150, using the molding kit 140, at step 102. This is performed by first placing the “work-up” 50 of the stock handle 10 in the molding kit 140. The “work-up” 50 of the handle 10 is then closed in the molding kit 140, and the impression 150 is prepared in both impression sections 149 of the molding kit 140.

Since the molding kit 140, according to the invention, includes either an instruction sheet 146 or options chart 144, at step 103, the customer selects optional content and/or provides further instructions to the manufacturer. The options available, in the embodiment shown, include material composition (i.e. wood, polymer, or composite), color, tactile properties such as hardness and adhesion, and quantity.

At step 104, the customer closes and ships the molding kit 140, which is prepared for easy, quick shipment to the manufacturer.

At step 105, the manufacturer receives the molding kit 140 from the customer and processes the impression 150. Any supplemental instructions, provided with the molding kit 140, are also processed for manufacturing. However, before manufacturing begins, the manufacturer may optionally prepare and further provide a 3-D rendering of the custom sports handle 60 (step 106).

If the manufacturer decides to provide a rendering, then the 3-D rendering is prepared according specifications provided by the molding kit 140 (step 500). This 3-D rendering is provided to the customer at step 502 in order to review and approve the final design of the custom sports handle 60. At this point, in step 504, the customer can request revisions or spot errors in the processing. Fundamentally, the 3-D rendering is a virtual mock-up of the custom sports handle 60, providing a visual representation of the final design, including size, shape, and texture.

The 3-D rendering may be provided to the customer electronically using an email or website address (step 502). However, it is also possible to provide a print-out of the 3-D rendering, which is then shipped to the customer for review and approval.

Further refinement of the custom sports handle 60, including the color and personalization, as well as final approval is confirmed at step 504. For example, the customer can apply a proper name, mark, or logo to the surface of the grip portion 62. Or, the customer may develop a pattern, which is later applied to the surface of the grip portion 62 and viewed through the tactile layer 80.

Once approved, the manufacturer will choose the appropriate manufacturing method at step 110, which depends on the user preferences. If the manufacturer determines to use a computer method of manufacturing step 111, the impression 150 will be scanned to capture three-dimensional data step 112. Otherwise, the manufacturer will use a mechanical method of manufacturing at step 116. The manufacturer processes the impression 150 in steps 118-120 of the molding kit 140 to make a mold, which is used to create one or more custom sport handles 60.

At step 118, the manufacturer incorporates the user selected material into the manufacturing method. If the selected material is metal or wood, the custom sports handle 60 is machined. However, if the user selected material is a thermoplastic, thermoset, or moldable material, the custom sports handle 60 is molded or formed. In either case, the manufacturing of the monolithic grip portion 62 of the custom sports handle 60 is performed at step 119.

If the custom sports handle 60 is machined at step 119, the manufacturer machine cuts a blank according to the impression 150 dimensions, and further applies some of the selected options, including contours and tactile properties. If a mold of the impression 150 is taken, then the manufacturer may prepare the custom sports handle 60 using injection, injection blow, or rotationally molding at step 119. However, other techniques are also possible, including casting, pressure bag molding, and vacuum bag molding.

At this point, the monolithic grip portion 62 is prepared, as well as an attachment portion 68 having a user selected attachment mechanism 69, which is selected as an option. For instance, retention members 70 would be prepared with the attachment portion 68 at step 119. User selected color is also incorporated into the manufacturing at step 119, since the selected material being machined, formed or molded can be prepared from a variety of colors.

At step 120, user selected graphics, additional exterior coloring and a user preferred tactile layer 80 are applied.

In the embodiment shown, the tactile layer 80 is sprayed on. However, other coating processes, known to the art, may be used. The thickness of the tactile layer 80 is an additional user selected option.

Once the custom sports handle 60 is manufactured, the custom sports handle 60 is prepared for shipment to the customer (step 121). A small spray bottle (not shown), which includes a liquid mixture of user selected tactile layer 80, is also provided with the custom sports handle 60 to allow the customer to reapply the tactile layer 80.

At step 122, the custom sports handle 60 is mounted.

At step 123, the manufacturer keeps a record of the specifications and/or mold for future orders.

In another embodiment of the invention, the method and means for preparing a custom sports handle 60 would be similar to the methods and means described above (FIG. 3A). However, instead of using the molding kit 140, as described in FIG. 3A, the customer would us the alternate kit 240 prepare a “work-up” 50 from a mock handle 241 from FIG. 3B. Accordingly, once the user prepares a “work-up” 50 of the mock handle 241, the user then places the modified mock handle 241 in the cavity 252 for shipment to the manufacturer.

In FIG. 5 yet another method and means for preparing a custom sports handle 60 according to the invention is shown and will now be described. At step 300, a customer logs onto a website or opens software of the manufacturer. The website or software has as a general user interface (hereinafter referred to as “GUI”), whereby the customer prepares a “work-up” 50 of a virtual handle (not shown). The GUI, having virtual instruments, is provided to the customer as a virtual handle kit (not shown).

At step 301, the customer selects a basic handle shape from a library of various shapes. At this point, the customer further modifies the shape of the virtual handle using various virtual tools. For instance, the same accessories and tools, used in preparing the “work-up” 50 for the molding kit 140 or 150, in this embodiment are virtual tools. As a result, the customer can modify the virtual handle in a similar way, as discussed above.

At step 302 the customer selects the type of mount and butt ends (i.e. flange, ridges, etc.) for the custom sports handle 60, as well as the type of attachment mechanism 69. The customer may further refine the design of the “work-up” 50 of the virtual handle.

At the next step, step 303, the customer selects from a library, the type of material(s) used to prepare the grip portion 62 of the custom sports handle 60. Next, the color is selected, with the color being chosen from a palette having a large number of color selections. At this time, a pattern may be chosen as well (step 304). The chosen color and pattern is applied to the grip portion 62 of the custom sports handle 60.

At step 305, the customer selects the firmness of the custom sports handle 60. The tactile properties of the tactile layer 80 may be chosen at step 306, including no tact, light, medium, or heavy. As a result, this selection helps determine the composition of the tactile layer 80.

At an optional step 307, the customer may add a name, logo, or brand to any surface of the grip portion 62 of the custom sports handle 60. The customer selects characters and graphics, including font and character effects (i.e. recessed, raised lettering), and then positions the selection using the GUI.

Once the customer is satisfied with the “work-up” 50 of the virtual handle 344, the customer chooses the desired quantity (step 308). Billing information is entered, and the customer transmits the order to the manufacturer, either electronically or through the mail.

At this point, further manufacturing steps are performed starting at step 105 in FIG. 4.

As shown in FIG. 6, the custom sports handle 60 connects to a hollow shaft 2 of a known hockey stick using a selected attachment portion 68. In the embodiment shown, the selected attachment portion includes retention members 70.

The retention members 70 are configured as finger-like members extending diagonally from all outer surfaces of the attachment portion 68. Each retention member 70 is resilient and extends in a direction away from a direction of insertion I into the hollow shaft 2. As such, the custom sports handle 60 can be inserted into varying sizes of a hollow shaft 2. The size and shape of the retention members 70 may vary, but should be large enough to provide adequate resistance once inserted into the hollow shaft 2.

Additionally, hot melt adhesive 71 may be positioned between and around each retention member 70. However, the use of hot melt adhesive 71 is optional, and is not necessary. Any type of adhesive 71 maybe used, however, in the embodiment shown, the adhesive 71 is a thermoplastic, which may be heated to soften during insertion and removal, yet hardens when cooled to room temperature.

In another embodiment, the retention members 70 connects to an attachment receiving piece 500, as shown in FIG. 6B. The attachment receiving piece 500 is a piece that connects to the interior 6 of the hollow shaft 2. The attachment receiving piece 500 includes an aperture in the center and holding members 502 that extend from an inner surface of the attachment receiving piece 500. The holding members 502 are configured as finger-like members and extend in a direction toward the center of the aperture, and further in a direction opposite to the direction that the retention members 70 are extending.

An adhesive may be used to hold the attachment receiving piece 500 in place. However, in the embodiment shown, securing members 503 are used to rigidly hold the attachment receiving piece 500 in a position within the hollow shaft 2. The attachment receiving piece 500 is a rigid structure, and is meant to maintain connection with the hollow shaft 2, so that a number of replacement custom sports handles 60 can quickly attach to the shaft for use.

In the embodiment shown, the retention members 70 are made from a resilient, breakable material, while the holding members 502 of the attachment receiving piece 500 are made from a much more rigid, sturdy material (i.e. metal or composite).

During insertion of the custom sports handle 60 into the hollow shaft 2, each retention member 70 resiliently bends toward the surface of the attachment portion 68. More specifically, each retention member 70 bends when contacting the peripheral edge 4 of the shaft 2. Since the hollow shaft 2 is void, the attachment portion 68 is fully received.

The retention members 70 apply enough resistance along the inner surface 6 of the shaft wall 2, that the retention members 70 hold the custom sports handle 60 in the shaft 2. If a hot melt adhesive 71 is used, then the retention members 70 will be further held within the shaft 2, once the hot melt adhesive 71 sets, which maintains the desired positioning.

If the attachment receiving piece 500 is used, the attachment receiving piece 500 is received within the hollow shaft 2 before placement of the attachment portion 68 of the custom sports handle 60. The attachment receiving piece 500 is positioned in such a way that the attachment receiving piece 500 sits flush with the peripheral edge 4 of the hollow shaft 2.

As the attachment portion 68 enters the hollow shaft 2 of the custom sports handle 60, the retention members 70 of the attachment portion 68 further receive through the aperture of the attachment receiving piece 500, deflecting away from the inner surface 6 of the hollow shaft 2. As the retention members 70 engage the holding members 502 of attachment receiving piece 500, a strong connection is formed.

In fact, the retention members 70 are received easily, in one direction (i.e. the direction of insertion I), by the attachment receiving piece 500. However, the attachment portion 68, having retention members 70, is not easily removed, since the retention members 70 are engaged with the holding members 502 of the attachment receiving piece 500. At a critical point, deformation of the retention members 70 occurs, and the attachment portion 68 is capable of removal. The force needed to disengage the retention members 70 and holding members 502 should rise above those forces normally exerted to the custom sports handle 60 during use. Applying heat to this process can lower the amount of force necessary to deform the retention members 70, allowing removal to occur with less of a robust force. Without any heat, the robust force must rise to the level that the retention members 70 deform or break, so that the custom sports handle 60 can be removed from the hollow shaft 2.

As a result, the custom sports handle 60 having retention members 70, which engage with holding members of an attachment receiving piece 500, can be quickly and easily attached to a hollow sports handle 2. Additionally, the custom sports handle 60 may be removed by deforming the retention members 70 or securing members 500, which may be screws, bolts, adhesive, or other known attachment means.

The foregoing illustrates some of the possibilities for practicing the invention. Many other embodiments are possible within the scope and spirit of the invention. In fact, the aforementioned methods, processes and apparatuses may be applied to various sports handles. It is, therefore, intended that the foregoing description be regarded as illustrative rather than limiting, and that the scope of the invention is given by the appended claims together with their full range of equivalents.

What is claimed is:

1. A custom sports handle, comprising:
a grip portion having a distal end and a proximal end;
at least one elongated projection integrally positioned along a surface of the grip portion;
a tactile layer prepared over the surface of the grip portion by way of a coating process.

2. The custom sports handle according to claim 1, wherein the tactile layer is a composition having a blend of rubberized material and grit.

3. The custom sports handle according to claim 2, wherein the composition further includes cork.

4. The custom sports handle according to claim 3, wherein the composition further includes silica and a binder.

5. The custom sports handle according to claim 1, further comprising an attachment mechanism at the proximal end of the grip portion.

6. The custom sports handle according to claim 5, wherein the attachment mechanism includes an adhesive.

7. The custom sports handle according to claim 6, wherein the attachment mechanism includes retention members.

8. The custom sports handle according to claim 5, wherein the grip portion includes at least one ridge along the distal end of the grip portion.

9. A molding kit for a custom sports handle, comprising:
a container having a hollow interior with a pair of cavities, corrected by a spine;
a deformable material positioned in the pair of cavities;
a pair of impression sections positioned on both sides of the spine; and
a pair of apertures along one side surface of the container and corresponding to each other when the container is closed.

10. The molding kit for a custom sports handle according to claim 9, wherein the deformable material is capable of plastic deformation.

11. The molding kit for a custom sports handle according to claim 10, further comprising a stock handle and tools used to modify the stock handle.

12. The molding kit for a custom sports handle according to claim 9, further comprising an options chart having a checklist of user selected options.

13. The molding kit for a custom sports handle according to claim 12, further comprising a sealing mechanism that self seals the container when closed along the spine.

14. A method of making a custom sports handle, comprising the steps of:
providing a kit to prepare a work-up of a stock handle;
preparing the work-up of the stock handle;
choosing user options from an options sheet in the kit;
sending the work-up of the stock handle and user options to a manufacturer;
preparing a rendering according to the “work-up” and user selected options;
manufacturing a blank having a grip portion;
applying a coating layer to the grip portion, the coating layer having a composition according to tactile properties selected from the options sheet; and
recording specifications of the work-up for future orders.

15. The method of making a custom sports handle according to claim 14, wherein the kit includes:
a container having a hollow interior with a pair of cavities, and a spine along the pair of cavities;
a deformable material positioned in the pair of cavities, the deformable material is removable from the pair of cavities;
a pair of impression sections positioned on both sides of the spine; and
a pair of apertures along one side surface of the container and corresponding to each other when the container is closed.

16. The method of making a custom sports handle according to claim 15, further comprising the steps of:
making an impression of the work-up of the stock handle in the pair of impression sections of the kit; and
manufacturing the blank according to the impression and selected options from the options sheet in the kit.

17. The method of making a custom sports handle according to claim 14, further comprising the step of:
preparing a rendering of the custom sports handle according to specifications provided in the kit.

18. The method of making a custom sports handle according to claim 17, wherein the rendering is a virtual mock-up of the custom sports handle, providing a visual representation of a final design, including size, shape, and texture.

19. The method of making a custom sports handle according to claim 17, further comprising the steps of:
providing the rendering to a customer electronically using an email or website address.

20. The method of making a custom sports handle according to claim 14, wherein the coating layer includes a blend of rubberized material, grit, silica, and cork.

21. The method of making a custom sports handle according to claim 14, further comprising the step of:
providing a spray bottle having a liquid mixture of the selected coating layer for further reapplication of the coating layer.

22. The method of making a custom sports handle according to claim 14, wherein the kit is a software application having a general user interface to prepare a work-up of the stock handle, the software application having virtual instruments, tools and a library of handle shapes.
